(19) United States
(12) Patent Application Publication
(10) Pub. No.: US 2025/0144650 A1
(43) Pub. Date: May 8, 2025

(54) BAG ON VALVE TECHNOLOGY

(71) Applicant: SIMPLY BREATH HOLDINGS LIMITED, Beverley, Yorkshire (GB)

(72) Inventors: Joe Michael Barratt, Beverly Yorkshire (GB); Thomas Anthony Ryan, Richmond Yorkshire (GB); Matthew Sygrove, Halifax Yorkshire (GB)

(21) Appl. No.: 18/839,020

(22) PCT Filed: Feb. 16, 2023
(86) PCT No.: PCT/IB2023/051411

§ 371 Date: Aug. 15, 2024

(30) Foreign Application Priority Data
Feb. 17, 2022 (GB) 2202107.5

(51) Int. Cl. B05B 7/04; B65D 83/141; B65D 83/38; B65D 83/52

(52) U.S. Cl. CPC B05B 7/0483; B65D 83/141; B65D 83/38; B65D 83/52

(57) ABSTRACT

A dispenser may include a dispenser container filled with a dispensing aerial carrier gas fitted with a valve assembly. The valve assembly may include a mounting cup, at least one gasket, a valve seat, a spring, a housing, and a dividing boss including a first fitment and a second fitment. The dispenser container may be absent of an adsorbent. The dispenser may be partially filled with an ingredient for dispensing and/or the ingredient for dispensing may be contained in an ingredient containing reservoir. The first fitment, along which the ingredient is carried, may be connected to at least one of a dip tube and a tube and ingredient containing reservoir. On actuation, the ingredient may travel out via the first fitment and the dispensing aerial carrier gas may travel out via the second fitment via a reducer insert which manages respective flow rates of the dispensing aerial carrier gas.

### CROSS-REFERENCE TO RELATED APPLICATIONS

This application claims priority to International Patent Application No. PCT/IB2023/051411 filed Feb. 16, 2023, which also claims priority to Great Britain Patent Application No. GB 2202107.5 filed Feb. 17, 2022, each of which is hereby incorporated by reference in its entirety.

### TECHNICAL FIELD

This invention relates to improvements in a delivery technology referred to in the industry as bag-on-valve (BOV) technology and to a dispenser for use with a modified valve assembly, not necessarily using the bag, and in which a dispensing aerial gas is released. The dispenser, and method of delivery, utilise a dispensing aerial carrier gas, (a gas composed of air or one of the natural components of air), which is absent of an adsorbent, typically activated carbon. It is a further modification to the disclosure in WO2020/021473 and seeks to provide a lower cost solution to delivery using aerial gases.

### BACKGROUND

The global bag on valve market was worth US$356.5 m in 2016 and is growing due to the rising awareness about its cost-effectiveness amongst consumers and manufacturers. Consumers are showing a strong inclination toward bag-on-valve technology as a packaging solution as it minimizes product wastage and prevents contamination, thereby ensuring value for money. Thus, this technology is being used for several high-end products. Yet another noticeable benefit is the environmental benefits this technology brings.

For the manufacturer, the preference for bag-on-valve promises a longer shelf life for oxygen sensitive products that contain fewer or no preservatives. Furthermore, various types of viscous and liquid products can be packaged using bag-on-valve technology, irrespective of the fact that they may be water or organic solvent-based. A growing number of manufacturers are also investing in this technology as the absence of propellant in the product reduces the risk of explosion or fire and of contamination. Also, the efficient filling process is an additional advantage.

However, there are limitations and challenges resulting from the propellants used and the pressure drop during operation which, for example, preclude the complete emptying of the bag.

Current aerosol devices take one of two forms as set out below:

In a conventional aerosol canister, the canister is partially filled with an active ingredient dissolved in an organic solvent. Liquified gas propellant (e.g. butane) is added and partially dissolves in the solvent. A dip leg extends from the valve to the bottom of the canister. On actuation, the vapour pressure of the propellant causes the liquid to travel up the dip tube and to be discharged from the actuator nozzle. The dissolved propellant causes the dissolved active ingredient and solvent to be aerosolised and atomised (broken up) to form the aerosol spray. Furthermore, the vapour pressure of the propellant remains constant until all of the liquid propellant has been used. Only then does the pressure fall, by which time all of the active ingredient will have been discharged.

If compressed gas is used as the propellant, then very little of the gas is dissolved in the solvent and the discharge is much less aerosolised and atomised with the compressed gas residing mostly above the liquid layer in the can. Additionally, the pressure of the system falls somewhat as the liquid level (active ingredient solution) diminishes because the compressed gas occupies a larger volume than it had originally.

In an alternative form, the aerosol dispenser may employ a bag-on-valve. This will typically use compressed air, which is used to squeeze the bag, on actuation, and release the contents of the bag. The discharge in this case, however, is not aerosolised and atomised since there is no gas mixing with the bag contents. This system is typically used to release creams or lotions. A bag-on-can is a variation of the bag-on-valve and is used to dispense, for example, shaving gel.

These types of systems are disclosed in e.g. CA2412424, U.S. Pat. No. 5,125,546, EP0343843, U.S. Pat. No. 617,907 and U.S. Pat. No. 4,141,472, all of which use liquified gas propellants.

However, legislation has been brought in to remove the high Global Warming Potential (GWP) of liquified gas propellants from aerosols.

In contrast, the dispenser of the invention uses aerial gases, particularly carbon dioxide (CO₂), which means it has no nett GWP. This is because whilst the GWP of CO₂ is 1, it is derived from the atmosphere, and so the net effect of using it is zero. CO₂ is preferred due to its solubilising effect of many ingredients as compared to other aerial gases.

This contrasts with the new liquified gas propellants (such as HFO-1234ze) which have low GWP because they break down in the atmosphere within a short period of time. However, the breakdown products are pollutants.

Fluorocarbon-based propellants are subject to a never-ending cycle of regulatory change. However, aerial gases are exempt from legislation such as the REACH regulation.

Over the last 12 years in the UK there has been a nett reduction in VOC emissions of 30%. However, in that time, the emissions from aerosols have increased by 10%, which is roughly in line with the increase in population size over this period. Since 2005 the emissions from aerosols have grown from 4.7% to 7.9% (2017). The Government wants to reduce total VOC emissions by 38% by 2030 and BAMA (British Aerosols Manufacturing Association) want to develop plans to reduce VOC emissions in aerosols whilst maintaining the high levels of product performance, consumer acceptance and safety.

A reason for the continued use of hydrocarbon and fluorocarbon-based propellants is that compressed aerial gases have not, to date, been stored in a sufficient quantity to enable ingredients to be fully discharged from a bag on valve aerosol can, hence Applicants' earlier publication WO2020/021473.

Applicants prior use of activated carbon to enhance the gas storage volume enables the contents of normal sized pouches to be discharged in full. Pouches, like canisters vary in size and typically include those holding volumes of from 35-50 ml, greater than 50-150 ml, greater than 150-250 ml and greater than 250 ml and are typically used in canisters of respectively 30 ml-100 ml, above 100 ml-275 ml, above 275 ml-500 ml and above 500 ml.

Further, by avoiding the use of solvents and liquified gas propellants solvent abuse is mitigated.

Aerosols that use water as a solvent and compressed air propellants have poor (low force) performance and produce a wet spray with a low plume. In contrast the dispensers described in WO2020/021473 produce an almost dry spray with good force and plume.

Additionally, whilst traditional aerosols are subject to dip-tube inversion, causing the release of excess propellant, the dispensers described in WO2020/021473 avoid inversion problems.

Also, regular bag-on-valve technology does not enable the active ingredient in the bag to aerosolise whereas the dispensers described in WO2020/021473 enables atomization (breaking up of the liquid into fine particles) and aerosolization (dispersal into an aerosol form).

Products available in the global market are aerosol BOV, standard BOV, and non-spray/low pressure BOV. Of these, the aerosol BOV is expected to acquire over 60% of the global market by the end of 2024.

The top four players are Aptar Group, Inc., Coster Tecnologie Speciali S.p.A, Toyo & Deutsche Aerosol Gmbh, and Summit Packaging System, Inc. These companies collectively held a share of about 39% in the global market in 2015.

The valve or valve assembly comprises either a male or female valve which is connected or crimped to a dispenser container or canister which is made of aluminium, tin plate, steel or plastics. Typical dispenser container capacity falls into one of the following size categories: below 30 ml, 30 ml-100 ml, above 100 ml-275 ml, above 275 ml-500 ml and above 500 ml.

Typical applications include applications for the following product types: Cosmetics & Personal Care products, e.g., deodorants, antiperspirants and hairsprays, Pharmaceutical and Healthcare products, Home Care products, e.g. air fresheners, and cleaning preparations, Food & Beverage products e.g. cream and cheese, and Automotive & Industrial products e.g. paints.

These traditional bag-on-valve dispensers, like aerosol dispensers, normally contain one of two types of propellant.
i) Liquefied gas propellants, which are primarily hydrocarbon based (e.g. propane/n-butane/iso-butane blends); or
ii) Hydrofluorocarbon based, (e.g., HFC-134a, -152a or HFO-1234ze).

The negative issues surrounding hydrocarbon propellants are well known, since these compounds are highly flammable, volatile organic compounds (VOC's) that are the subject of inhalation abuse and contribute to poor indoor air quality.

A further disadvantage arising from their flammable nature is filling lines require separate explosion proof facilities which add to process complexity and cost.

Another disadvantage with hydrocarbon-based propellants is that they have been found to be occasionally contaminated with organic materials that may be carcinogenic, e.g., benzene.

The hydrofluorocarbons are also replete with problems in aerosol applications, and HFC-134a, for example, has been recently legislatively phased out from use in many applications owing to its intrinsically high GWP.

Two condensed gas compounds that meet the new EU F-Gas Regulations for GWP<150 include:
HFC-152a (1,1-difluoroethane); and
HFO-1234ze (1,3,3,3-tetrafluoroprop-2-ene).

Unfortunately, HFC-152a (GWP˜120) is designated as highly flammable, and HFO-1234ze (GWP˜6) is conceded to be flammable above 28° C. It is also oftentimes prohibitively expensive.

Of course, where there is combustion of HFCs or HFOs there is also the release of hydrogen fluoride which is both very toxic and corrosive. Additionally, there is increased reporting of fluorinated hydrocarbon (HFC) abuse, particularly with HFC-152a, amongst young adults resulting in occasional deaths. It is too soon to report on the abuse of HFO-1234ze but there is every reason to assume that it will provide similar euphoric/asphyxiant properties to those of the HFCs. Finally, although there is only a small GWP contribution, the environmental breakdown of HFO-1234ze produces fluoroacetic acids which are toxic to plant and aquatic life. One of the atmospheric breakdown products of HFC-152a is carbonyl difluoride (COF₂) which hydrolyses in the lower atmosphere to give hydrogen fluoride.

Because of this it is desirable to avoid the use of such gases and to use compressed aerial gases where possible.

Whilst the development of a bag- and frit-on-valve assembly, as outlined in WO2020/021473, has many advantages and allows the use of non-harmful gases, e.g. aerial gases for dispensing a wide range of ingredients in a wide range of applications the activated carbon adds to the cost making it less attractive, despite its clear benefits. In certain, low cost, applications, aerial gases, such as air, nitrogen, oxygen, argon or carbon dioxide can be used. These are cheap, readily available, and have low toxicity and are without risk of phase-out. These gases are also not amenable to regulation such as the REACH Regulation.

Unfortunately, aerial gases cannot be condensed without refrigeration, or the use of extreme pressures (below the respective critical temperatures) to provide gas in sufficient quantity for aerosol applications. Compression of these gases into dispenser containers is easily possible although the maximum, permitted pressure is limited such that the contents pressure does not exceed 15 barg when the canister and its contents are raised to the test temperature of 50° C. for 3 minutes, according to the Aerosols Directive. This restriction means that a canister must not be filled much above 12 barg at room temperature. Under such conditions, upon actuation, the pressure drops rapidly as the canisters' contents are discharged, and the overall gas volume delivery is small giving rise to a small number of delivered applications and poor customer perception.

By way of a non-limiting example, a standard air freshener employing a liquefied gas usually contains an ingredient (product concentrate) and a solvent in addition to the liquefied propellant, either hydrocarbon or HFC with all of the disadvantages as already described. Additionally, there is the possibility of product misuse resulting from dip-tube inversion giving a disproportionate loss of propellant. A standard compressed air-based, air freshener, might thus contain 5% ethanol in water compressed with air in addition to a dissolved fragrance concentrate. Such devices tend to deliver a short, wet spray and although this system does not contain any liquefied gas propellant, it still contains solvent and exhibits poor performance.

In view of the shortcomings described for both liquefied gas-containing aerosols and for compressed gas-containing aerosols, it appears that an aerosol canister containing neither liquefied gas propellant nor solvent would be advantageous.

Whilst bag-on-valve technology enables the active product to be separated from the propellant (typically compressed air or nitrogen, or a condensed liquified gas), to maintain complete integrity of the product so that only pure product is dispensed, these standard bag-on-valves do not aerosolise because they do not release the propellant, but they can atomize the liquid products when sprayed.

In consequence their use is limited to, for example, the dispensation of liquids, including viscous liquids, solutions, lotions, creams, pharmaceutical preparations, gels, olive oil and other food products, such as processed cheese. A benefit of having the ingredient in the bag, is the active ingredient is protected from oxygen which might otherwise cause the product to spoil, and it is protected from contact with the propellant because the propellant is filled into the space occupied between the bag and the can.

Prior art, separate of traditional bag-on-valve dispensers, include art relating to adsorbent carbon technology such as Applicant's own UK application no GB1703286.3, and WO 2014/037086, in which an aerial propellant gas is adsorbed onto activated carbon contained within a canister (in the space between the bag and the canister) which enables a more even dispensation of the contents of the bag compared to a compressed gas alone. Like the traditional bag-on-valve arrangements, no gas is discharged from the canister.

DE1817899 discloses a dispenser comprising a liquified gas propellant. A liquid to be atomised is contained in a bag located in the container and a double valve allows for a fluid flow circuit in which the liquid is atomised as it is sucked up by means of a venturi tube.

It is an object of the present invention to address the challenges of using BOV technology with aerial gases.

### SUMMARY

In accordance with a first aspect of the present inventions there is provided a dispenser (20) comprising a dispenser container (90) filled with a dispensing aerial carrier gas (140) fitted with a valve assembly (10) comprising:
i) a mounting cup (30);
ii) one or more gaskets (40; 42; 44);
iii) a valve seat (50);
iv) a spring (60);
v) a housing (70); and
vi) a dividing boss (80) comprising a first fitment (182) and a second fitment (184) characterised in that the dispenser container (90) is absent of an adsorbent, and is either:
a) partially filled with an ingredient (100) for dispensing, or
b) the ingredient for dispensing is contained in an ingredient containing reservoir (110/150), and
   the first fitment (182) of the dividing boss (80), along which the ingredient is carried, is either connected to
vii) a dip tube (152); or
viii) a tube and ingredient containing reservoir (82; 110; 150)
   such that on actuation the ingredient (100) travels out via the first fitment (182) of the dividing boss (80) and the dispensing aerial carrier gas travels out via the second fitment (184) of the dividing boss (80) via a reducer insert (300) which manages respective flow rates of the dispensing aerial carrier gas and ingredient allowing the ingredient and dispensing aerial carrier gas to mix within a mixing chamber (280) of an actuator assembly (15) such that substantial atomisation or aerosolization of the ingredient occurs on discharge when exiting the dispenser container (90) via an actuator spray nozzle (220) to an environment or subject at an average flow rate of 0.4 g/s or greater.

The dividing boss and fitments may also be referred to as a manifold with two inlets and an outlet which communicates with the valve stem.

The key to the invention is matching:
i) dispenser container volume;
ii) ingredient containing reservoir volume;
iii) dispensing gas pressure, and importantly
iv) tube and orifice diameters, such that the respective flow rates of the dispensing aerial gas and ingredient, at the point of mixing, are matched to ensure substantial atomization and aerosolization of the ingredient.

Without such controls ingredients are not fully dispensed and the quality of the exiting plume is poor.

Applicant has determined that for certain applications it is possible to deliver substantially all of an ingredient, in a satisfactory manner, using an aerial gas, particularly carbon dioxide, which is a good solubilizer, by carefully controlling the release of the dispensing gas and ingredient through careful design of a valve and actuator assembly.

More particularly, Applicant has used, in addition to the dividing boss, a reducer insert at the point of mixing, to ensure substantial atomization or aerosolization of the ingredient with the carrier gas.

The reducer insert has been configured to increase the flow rates and more particularly to facilitate faster flow of the carrier gas relative to the ingredient. By using a reducer insert, Applicant has been able to achieve substantial emptying of ingredients and its delivery in a substantially dry plume (where the ingredient is in an aqueous solution). In a particularly favoured embodiment, the Applicant has selected a ratio of the diameter of the aerial gas conduit orifice to the diameter of the ingredient conduit orifice of between 1:2 and 1:8, more preferably 1:2 and 1:6.

In a first embodiment the liquid ingredient is held in the dispenser container and is drawn out using a long dip tube connected to the first fitment of the dividing boss.

In a second embodiment the liquid ingredient is held in a bag or pouch which is connected to the first fitment of the dividing boss.

In a variation of the first embodiment the long tube is an Anyway® spray tube such as described in WO2008037969, namely one in which the tube is sealed at one end and has nanopores along its length such that it preferentially transfers liquid to an aerial gas. Such an arrangement means the device can work in any orientation.

In all the embodiments above, the dispensing aerial carrier gas is drawn out via the second fitment of the dividing boss.

Preferably the ingredient-containing reservoir is a bag or pouch.

Alternatively, multiple ingredients can be dispensed by modifying the dividing boss. Thus, a trifurcating, as opposed to bifurcating, boss could have three tubes, at least two connected to ingredient containing reservoirs comprising different ingredients and one to the carrier gas. Any reducers are modified appropriately.

The dispenser may further comprise a metering device.

The dispenser may further comprise a spacer.

The dispenser is filled with a dispensing gas which is an aerial gas, such as air, nitrogen, oxygen, carbon dioxide or argon.

Most preferably the aerial gas is carbon dioxide since it is the gas that is most soluble in the dispensing liquids employed.

A benefit of the invention is that it is able to dispense an ingredient absent of a liquified propellant and/or a solvent.

The active ingredient may include any ingredient used in the cosmetics & personal care, pharmaceutical and healthcare, home care, food & beverage, and automotive & industrial sectors, including particularly, but not exclusively, a fragrance, flavour, pheromone, pesticide, medicinal, nutraceutical or pharmaceutical ingredient.

In the case of medicines and pharmaceuticals it is essential that a constant dose is delivered, and thus the dispenser is further adapted to deliver a metered dose and may additionally comprise a spacer. A constant dose may be controlled using an algorithm which controls the dispensing time of each dose.

In accordance with a second aspect of the present invention there is provided a method of delivering an ingredient (100) from a dispenser (20) which is absent of an adsorbent (130) comprising a dispensing aerial carrier gas (140) wherein the ingredient (100) is released from a dispenser container (90) or ingredient containing reservoir (110) under pressure together with the dispensing aerial carrier gas (140) which is also released on actuation of a valve assembly (10), which ingredient (100) and dispensing aerial carrier gas (140) travel respectively along a first fitment (182) and a second fitment (184) to a reducer insert (300) and along respectively a reducer aerial carrier gas conduit (270) and a reducer ingredient conduit (260) which manage the dispensing aerial carrier gas and ingredient flow rates, allowing the ingredient and dispensing aerial carrier gas to mix within a mixing chamber (280) of an actuator assembly (15) such that substantial atomisation or aerosolization of the ingredient occurs on discharge when exiting the dispenser container (90) via an actuator spray nozzle (220) to an environment or subject at an average flow rate of 0.4 g/s or greater.

According to a third aspect of the present invention there is provided a valve and actuator assembly (10;15) for a dispenser (20) comprising:
i) a mounting cup (30);
ii) one or more gaskets (40; 42; 44);
iii) a valve seat (50);
iv) a spring (60);
iv) a housing (70); and
v) a dividing boss (80) which communicates with at least two tubes (82; 84) seated within a dispenser container (90), a first tube (82), in use, connecting the boss via a first fitment (182) to an ingredient (100) containing reservoir (110/150), allowing the ingredient to be dispensed on actuation of the valve and the actuator assembly (10; 15) and a second tube (84), in use, connecting the boss via a second fitment (184) to a dispensing aerial carrier gas (140);
   wherein the valve and actuator assembly further comprises a reducer insert (300) comprising an ingredient flow conduit (260) of diameter (D1) and a reducer aerial carrier gas flow conduit (270) of diameter (D2) leading to a mixing chamber (280) which conduits manage the respective flow rates of the ingredient (100) and dispensing aerial carrier gas (140) allowing the ingredient and dispensing aerial carrier gas to mix within the mixing chamber (280) within the actuator assembly such that substantial atomisation or aerosolization of the ingredient occurs on discharge when exiting the dispenser container (90) via an actuator spray nozzle (220) to an environment or subject at an average flow rate of 0.4 g/s or greater.

Again, this mixing may be facilitated by an appropriate reducer.

In a preferred embodiment the ingredient is contained in a reservoir which is a bag or pouch.

In an alternative embodiment the ingredient is contained in a dispenser container and a dip tube extends to the bottom of the container.

In all embodiments the valve assembly further comprises an actuator assembly.

In yet another embodiment the valve assembly comprises three or more tubes and at least two ingredient containing reservoirs comprising different ingredients.

The valve assembly comprises a reducer insert to increase the flow rate of the carrier gas relative to the ingredient thereby ensuring aerosolization on release.

In yet a further embodiment the valve assembly comprises a metering device. The metering device preferably comprises a mechanism for adjusting the spray length to control dose volume with time.

A preferred ingredient is a fragrance and the product an air freshener. Other preferred ingredients include deodorisers and antiperspirants, hairsprays, pesticides, polish cleaners and emulsions, pharmaceuticals and other healthcare products.

Also, in order to control spray performance, a pressure of between 4 and 15 barg, more preferably 5 barg and greater, is preferred.

Flow of the dispensing gas and ingredient is controlled by fitting a reducer in the actuator or by judicious selection of a valve restrictor orifice. Indeed, it may be desirable to use different diameter tubes/valve orifices to control the ratio of ingredient: dispensing gas flow. Generally, ensuring a greater flow of the dispensing aerial gas to liquid ingredient will result in a drier plume.

Obviously, the discharge rate will vary with the ingredient but for many consumer goods it is desirable to have a discharge rate greater than 0.5 g/s.

Exemplary product discharge rates are illustrated in the Table 1 below:

TABLE 1

| Product Type | Average Discharge Rate (g/s) |
|---|---|
| Hairspray | 0.7 |
| Hair Mousse | 3.8 |
| Antiperspirant | 0.9 |
| Deodorant Body Spray | 0.5 |
| Shave Foam | 5.5 |
| Shave Gel | 10.5 |
| Air freshener | 1.5-1.8 |
| Furniture Polish | 1.8 |
| Bathroom Mousse/Spray | 4.0 |
| Starch | 2.0 |
| Carpet Cleaner | 2.0 |
| Oven Cleaner | 2.0 |
| Flying Insect Killer | 3.3 |
| Crawling Insect Killer | 3.0 |
| De-icer | 2.5 |
| Paints | 0.8 |
| Timed Release Air Freshener | 0.1 |

In some cases, it may also be desirable to include a small proportion of an entraining agent with the dispensing aerial carrier gas.

### BRIEF DESCRIPTION OF THE DRAWINGS

Embodiments and aspects of the invention are further described hereinafter with reference to FIGS. 3 to 9 of the accompanying drawings, with FIGS. 1 and 2 illustrating prior configurations:

FIG. 1A is an exploded view of a prior art male (single) bag on valve assembly;

FIG. 1B is a cross sectional view of the assembled valve assembly of FIG. 1A;

FIG. 2A is an exploded view of a first embodiment of a valve assembly of the invention disclosed in WO2020/021473;

FIG. 2B is an exploded view of a first embodiment of a dispenser comprising the valve assembly of FIG. 2A;

FIG. 2C is a side elevation of the assembled dispenser of FIG. 2B;

FIG. 2D is a cross sectional view of the dispenser of FIG. 2B/2C;

FIG. 2E is a detailed view of the encircled area of FIG. 2D;

FIG. 3A is an exploded view of the valve assembly of the invention and reducer;

FIG. 3B shows a dip tube to be attached to the ingredient inlet of the boss;

FIG. 3C shows an ingredient container of the folded bag to be attached to the ingredient inlet of the boss;

FIG. 4A is an exploded view of an actuator assembly of the invention and reducer;

FIG. 4B is a cross-sectional side view of the valve assembly, actuator assembly and reducer of the invention;

FIG. 4C is a cross-sectional front view of the valve assembly, actuator assembly and reducer of the invention;

FIG. 5 is an ingredient filled dispenser of one embodiment of the invention with a dip tube;

FIG. 6 is a dispenser of another embodiment of the invention with a bag, containing ingredient;

FIG. 7 is a variant of the invention using an Anyway® dip tube;

FIGS. 8A to 8C are figures showing respectively the solubility of the aerial gases carbon dioxide, nitrogen and oxygen in water (at atmospheric pressure); and

FIG. 9 is a graph showing flow rate vs time for a range of different sized containers where the ingredient volume and tube diameter remains constant under different pressures.

### DETAILED DESCRIPTION

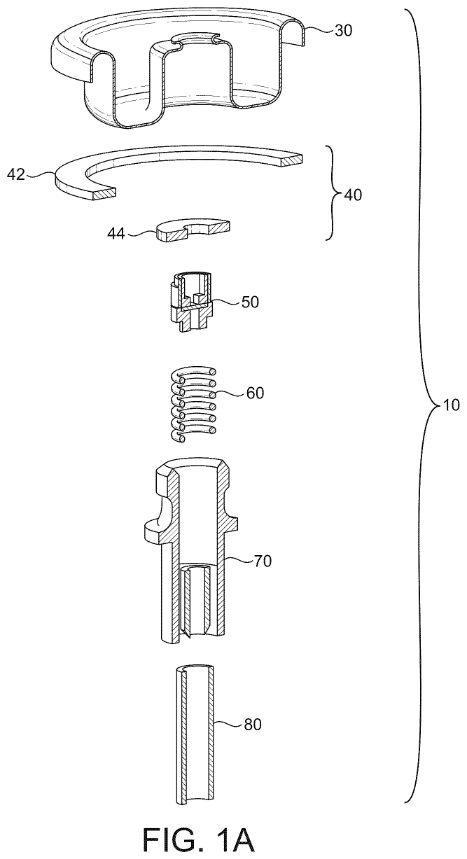

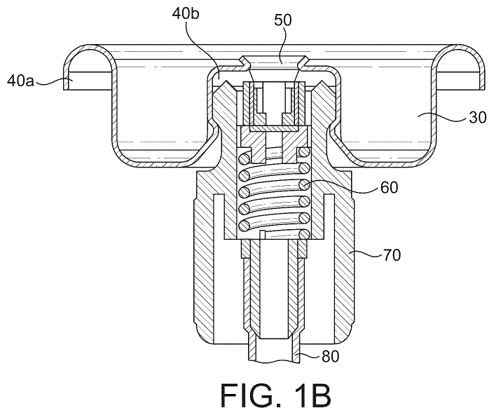

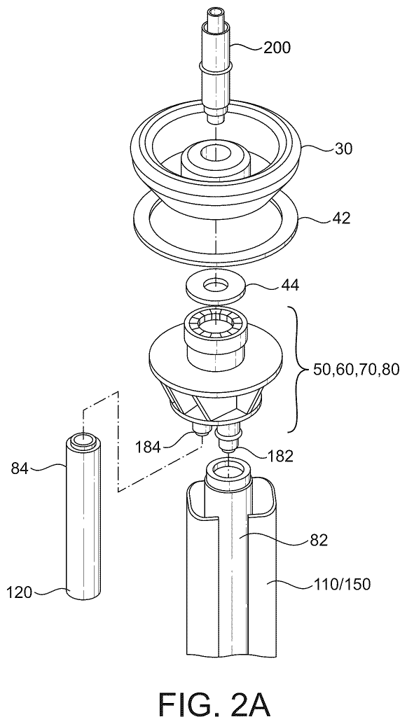

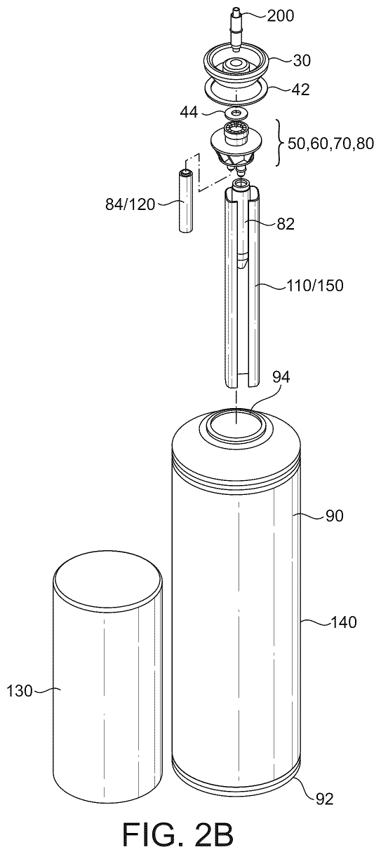

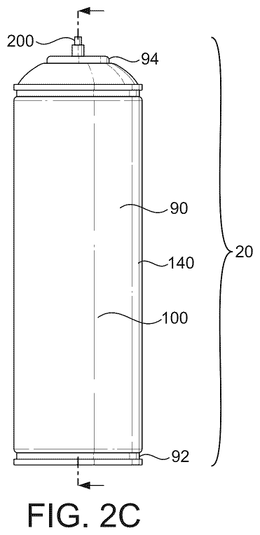

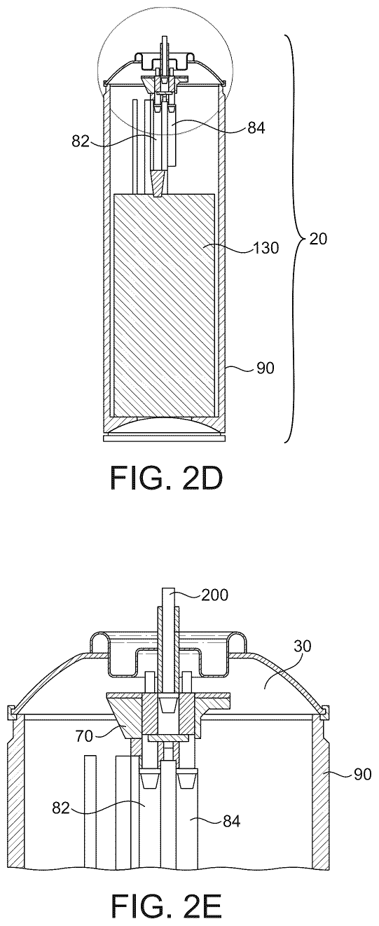

Referring to FIGS. 1A and 1B, a typical bag on valve assembly (10) comprises:
i) a mounting cup (30);
ii) an outer (42) and inner (44) gasket (40);
iii) a valve seat (50);
iv) a spring (60);
v) a housing (70); and
vi) a boss (80) with a fitment (182; 184), such as a rib, to which a bag (not shown) is attached (seen more clearly in FIG. 2A).

A valve stem (200) of an actuator (FIG. 2A) may be connected to the valve assembly (10) which may be a male valve (as illustrated) or a female valve.

In a variation to the single bag arrangement two companies, Lindal Group (Bi-valve) and Toyo Aerosol industry (Dual) have developed a dispensing system in which two bags are filled, allowing two different products to be dispensed, either as separate products, or more typically as a single product, with mixing occurring in the valve assembly. In the latter case the valve assembly has a dividing boss (80) which splits/bi-furcates into two fitments (182; 184 of FIG. 2A) for connecting e.g. a bag thereto. The bags are typically 3 layers, or 4 layers, pouches made respectively of polyacrylate/aluminium/polypropylene or polyethylene (PA/ALU/PP or PE) or polyethylene terephthalate/aluminium/orientated polyamide/polypropylene or polyethylene (PET/ALU/OPA/PP or PE).

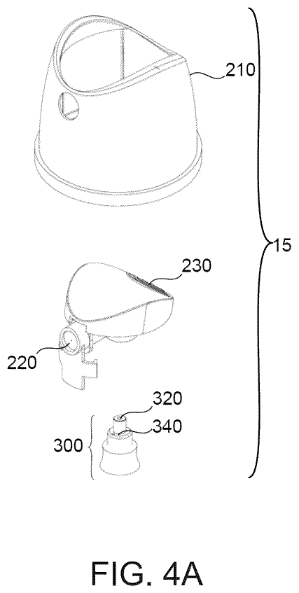

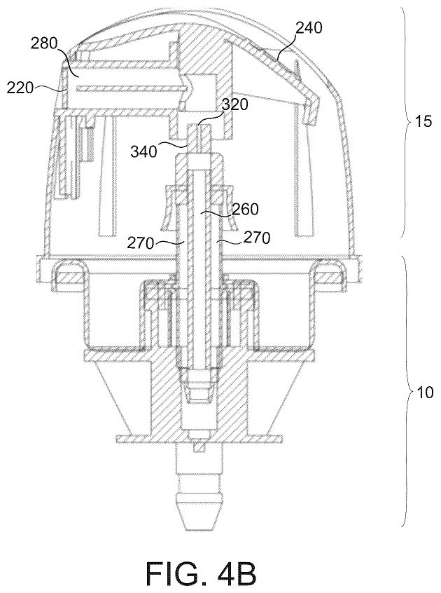

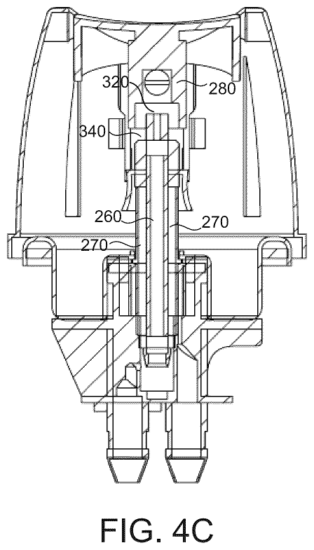

In contrast to this prior art, the valve assembly (10) according to WO2020/021473 (as best illustrated in FIGS. 2A and 2B) has a mounting cup (30), a pair of gaskets (42 and 44), a valve seat (50), spring (60) and housing (70), with a dividing boss (80) which divides, at its lower end, to receive two tubes (82; 84) on respective fitments (182; 184). An ingredient (100) containing reservoir (110) or bag or pouch (150) is connected to a first fitment (182) and, significantly, a frit or filter (120) is connected to a second fitment (184), which acts to prevent fine particles of activated carbon being dispensed, as in this prior art embodiment it was envisaged that a dispensing gas (140) would be held in a container (90) filled with activated carbon (130). Both tubes (82; 84) extend into dispenser container (90), which is filled with the dispensing carrier gas (140), typically carbon dioxide, which is adsorbed by the activated carbon (130) which fills or partially fills the dispenser container (90). On actuation, the dispensing carrier gas (140) is released together with the ingredient (100) stored in the (to be expanded bag) (150), and the ingredient (100) and carrier gas (140) mix as they pass through the valve assembly (10) to exit the dispenser container via the actuator spray nozzle (220), shown in FIG. 4A.

The dispenser (20) in this embodiment, as illustrated in FIGS. 2C and 2D, comprises a dispenser container or canister (90) which is filled or partially filled with activated carbon (130) and the valve assembly (10) is crimped, or otherwise sealed, to close the opening (94) (FIG. 2B) of the dispensing canister (90). The dispenser (20) may be charged with the dispensing carrier gas (140) before or after crimping or otherwise sealing, as disclosed in, for example UK application no GB1703286.3 incorporated by reference. Similarly, the bag or pouch (150) may be filled with its ingredients (100) before or after crimping.

This invention enabled, for example, essential oils/fragrances to be rapidly mixed by vaporisation/atomisation due to contact with a high velocity gas stream.

The active ingredient (100) is usually in the form of a liquid or oil but could be any mobile phase carrying the active ingredient.

The bag or pouch (150) is usually rolled into a hollow cylinder (See FIG. 2B) around first tube (82) for ease of insertion, and the adjoining second tube (84) and frit (120) is inserted into a canister pre-filled with granular activated carbon (130), first and second tubes (82) and (84) being connected to the valve assembly via fitments (182) and (184) respectively. (The granular carbon is easily displaced to accommodate the rolled-up bag which is now surrounded by the activated carbon granules). Alternatively, to avoid any possibility of tearing on inflation, the bag or pouch may sit just above the activated carbon granules. The canister (90) is then crimped, and the bag side of the canister is filled with the required quantity of active ingredient (100). The frit side of the valve is then filled with pressurised gas (usually, air, oxygen, nitrogen or carbon dioxide). On actuating the valve, the assembly enables the dispensing carrier gas (140), that is mixed or physically saturated, at least in part, with any active ingredient(s), for example, a fragrance for air freshening applications, a drug, or an insecticide. Where the dispensing gas is air or oxygen it is possible to provide a scented air or oxygen, mild enough to breathe. Filling the bag (150) with a medicinal preparation (such as plant oil or an active therefrom) and using the dispensing gas (140) allows for the use as a medical inhaler, optionally fitted with i) a dose regulator and ii) a spacer.

In the present invention the Applicant has determined that for some applications they can do away with the activated carbon (130) and frit (120) and achieve effective discharge of an ingredient using only a dispensing aerial carrier gas (140).

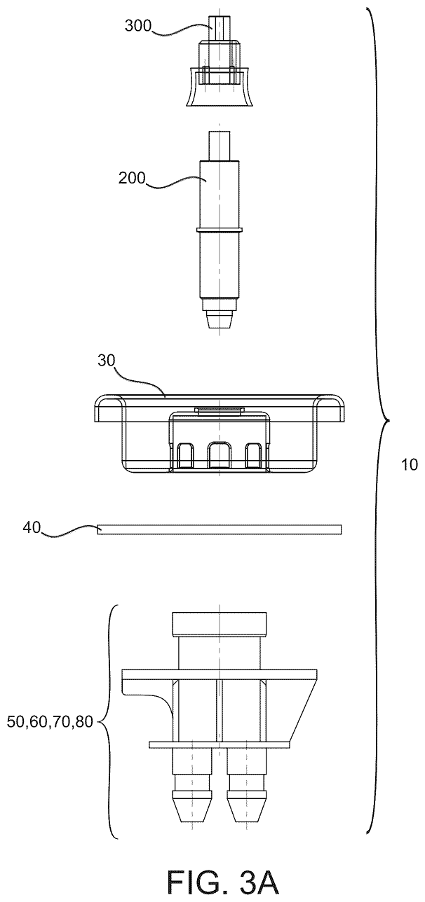

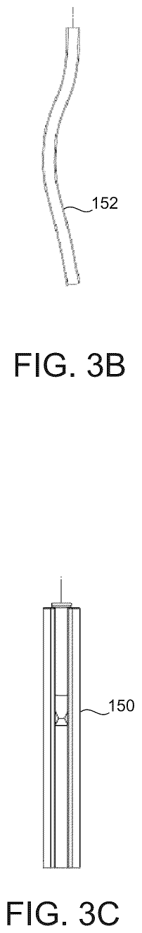

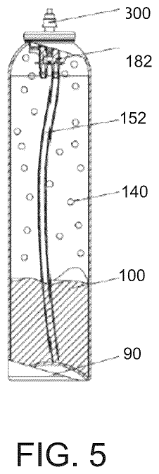

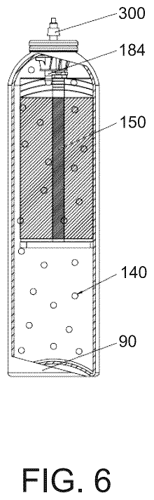

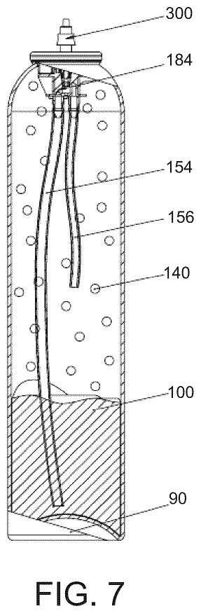

This can be achieved using a valve assembly substantially as illustrated with reference to FIG. 3A, FIG. 3B or FIG. 3C, a valve/actuator assembly, including a reducer, as illustrated in FIG. 4A, FIG. 4B and FIG. 4C, and dispensers as illustrated in FIG. 5, FIG. 6 and FIG. 7, and as further illustrated with reference to the Examples.

FIG. 3A refers to a valve assembly (10) and FIG. 4A refers to an actuator assembly (15). The valve assembly shown in FIG. 3A, comprises a valve stem (200) and reducer (300), positioned above the mounting cap (30), gasket(s) (40), valve seat (50), spring (60) housing (70) and boss (80). The boss has two fitments (182; 184) to which are connected respectively an ingredient carrying tube (82) and a gas carrying tube (84) as illustrated in FIG. 2A. The ingredient carrying tube (82) can take the form of a dip tube (152) (as FIG. 3B) or bag (150) (FIG. 3C).

The actuator assembly (15) and reducer (300) are illustrated in exploded view in FIG. 4A and comprise an actuator top (210), an inner body (230), and reducer (300) which sits over the valve stem (200)—see cross sectional views (4B and 4C). The actuator has an actuating mechanism, lever or button (240) which effects an action by depressing the valve stem (200) allowing ingredient to flow through (liquid) ingredient flow conduit (260) and a carrier gas to flow through gas flow conduit (270). The gas and ingredient mix in a mixing chamber (280) before exiting at nozzle (220).

In use, as will be apparent from the cross-sectional views (FIG. 4B and FIG. 4C) gas travels along gas flow conduit (270) before exiting at orifice (340) of the reducer (300), of diameter D2. In the example illustrated the diameter D2 is between 0.4 and 0.6 mm. Similarly, the liquid ingredient (100) travels along ingredient flow conduit (260) before exiting at orifice (320) of the reducer, of diameter D1. In the example illustrated the diameter D2 is between 0.7 and 1.0 mm. The exiting gas and liquid ingredient mix in mixing chamber (280). The diameter D2 is narrower than diameter D1, and the two are sized, to ensure mixing in chamber (280) causes aerosolization of the ingredient (typically dissolved or dispersed in a liquid) based on the dispenser volume and pressure (See Examples).

Exemplary filled dispensers are illustrated in FIGS. 5 to 7.

FIG. 5 illustrates a dispenser with a liquid ingredient held at the bottom (100) of a canister. A dip tube (152) connects the valve/actuator assembly to ingredient carrying fitment (182) and the ingredient conduit (260) and reducer orifice (320). The second gas carrying fitment (184) allows the carrier gas (140) to enter the carrier gas conduit (270) and reducer orifice (340). The carrier gas and ingredient mix in the mixing chamber (280) before exiting as a plume via the exit nozzle (220).

FIG. 6 illustrates a dispenser with a liquid ingredient held in a bag (150) in the canister. A tube within the bag connects the valve/actuator assembly to fitment (182), first conduit (260) and reducer orifice (320). Second fitment (184) allows the carrier gas (140) along second conduit (270) and reducer orifice (340). The carrier gas and ingredient mix in the mixing chamber (280) before exiting as a plume via nozzle (220).

FIG. 7 is a variant of the FIG. 5 embodiment in which an Anyway® tube (154) replaces the standard dip tube. The Anyway® dip tube has a closed end and nano-holes such that whichever way up it is orientated, liquid (but not gas) can travel through. A shorter dip tube (156) is attached to the gas side of the valve to enable the device to be operational on inversion because, on inversion, the liquid level will always be below the dip tube opening.

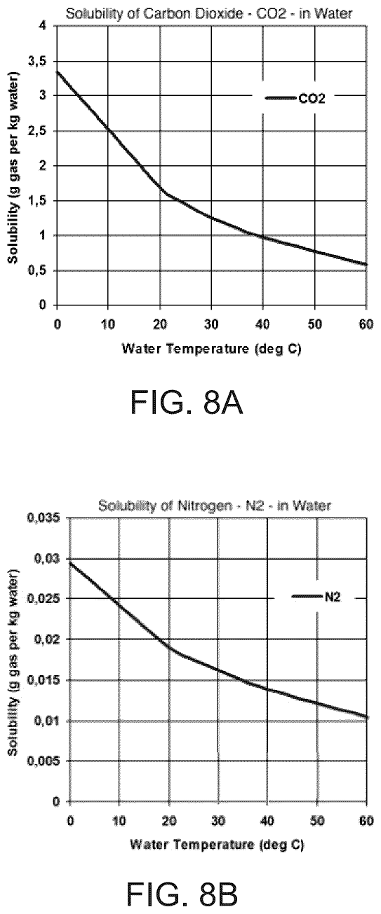

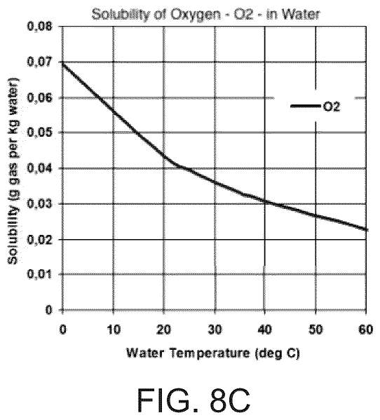

FIGS. 8A, FIG. 8B and FIG. 8C are graphs respectively illustrating the solubility of carbon dioxide, nitrogen and oxygen in water at atmospheric pressure, which demonstrates the benefits of using carbon dioxide as the dispensing carrier gas.

The proof that effective dispensing, producing a substantially dry plume, can be achieved without activated carbon is illustrated in the Examples below:

### Example 1

A commercially available dual valve (ex: Lindal Valve Co. Ltd.) was used in this example. It comprises a first tube (82) attached to the dividing boss (80) on the liquid side of the valve and second tube (84) attached to the dividing boss (80) on the gas side of the valve assembly (10), which remains open and unfettered and is absent of a frit or filter. The valve assembly was then inserted into a dispenser container (90) of 395 cm³ capacity containing 60 cm³ of water, ensuring that the first tube (82) on the valve assembly (10) extended to the bottom of the container. (In this Example a bag was not used. Rather the canister is used with a first tube that extends to the bottom of the container). The valve was then crimped on to the container.

The contents of the canister were pressurized to 10 barg with carbon dioxide by gassing through the open valve, resulting in a gas uptake of 6.8 g inside the can. Referring to FIG. 4A, the valve was then fitted with an actuator (Lindal T130.013) containing a flow restriction insert (300) such that the liquid flow orifice (320) (1 mm internal diameter (id)) and the gas flow orifice (340) (0.5 mm id) were in the area ratio (πr²) of about 4:1.

On actuation of the valve, the contents of the container were dispersed in a powerful, continuous spray over a time period of approximately 110 seconds. The throw of the spray was in excess of 1.5 metres with a uniform cone angle of 10-15 degrees, delivering a very useable spray over this time. The average flow rate was in excess of 0.5 g per second. On opening, the canister appeared to be essentially empty with only 4.5 g of water, in total, remaining on the interior surface of the can, corresponding to a discharge of about 92.5%.

Carbon dioxide has a solubility of about 17.7 g/litre of water at 10 barg and 20° C. and approximately 1 g of carbon dioxide was determined to be dissolved in the water (60 cm³) prior to the actuation and which is substantially released on reaching ambient pressure. This is believed to provide further enhancement of the atomization/aerosolization of the spray, contributing to its dry sensory feel. This assembly would provide for an excellent, environmentally-friendly air freshener.

### Example 2

The conditions of Example 1 were repeated except that a similar volume of an exemplary organic solvent, propylene glycol (η=0.042 Pa·s), was used in place of the water. On actuation of the valve, a powerful plume was observed, like that observed in Example 1, and which provided a useable, dry feeling spray for about 90 s. However, only 31% of this much more viscous liquid was discharged with an average flowrate of 0.21 g per second. The discharge also contained approximately 1 g of dissolved carbon dioxide which is believed to enhance the spray quality.

### Example 3

The dual valve described in Example 1 was assembled such that the liquid ingredient (water) was contained in a reservoir (110) in the form of an impermeable bag (of approximately 60 cm 3 capacity) connected to first tube (82). The second tube (84) on the gas (carbon dioxide) side of the valve remained open. The bag and valve assembly were inserted into containers of various capacities and the assemblies were crimped. The individual bags were filled with approximately 60 cm³ of water using a semi-automatic BOV filling machine, and the gas side of the valve was used to fill with carbon dioxide via a semi-automatic gas filling machine at 7, 10 and 13 barg pressure.

The results are shown in the Tables 2 to 4 below.

TABLE 2
Canister of Small Capacity (395 cm³)

| | | | | Discharge | | |
|---|---|---|---|---|---|---|
| Sample | Water | | Gas | Time/s | Liquid | Average |
| No. | wt./g | Pressure/barg | wt./g | (approx) | Discharged/% | Flowrate/g s−¹ |
| 1 | 59.37 | 7 | 4.59 | 120 | 74.31 | 0.37 |
| 2 | 59.61 | 10 | 6.67 | 120 | 90.02 | 0.45 |
| 3 | 60.18 | 13 | 8.59 | 120 | 94.75 | 0.48 |

| | | | | |
|---|---|---|---|---|
| 4 | 60.12 | 10 | 6.78 | Employed for flowrate tests |

TABLE 3
Canister of Medium Capacity (644 cm³)

| | | | | Discharge | | |
|---|---|---|---|---|---|---|
| Sample | Water | | Gas | Time/s | Liquid | Average |
| No. | wt./g | Pressure/barg | wt./g | (approx) | Discharged/% | Flowrate/g s−¹ |
| 1 | 61.18 | 7 | 8.25 | 134 | 94.05 | 0.43 |
| 2 | 61.26 | 10 | 11.94 | 103 | 96.33 | 0.57 |
| 3 | 61.39 | 13 | 15.34 | 78 | 96.75 | 0.76 |

| | | | | |
|---|---|---|---|---|
| 4 | 61.33 | 10 | 11.63 | Employed for flowrate tests |

TABLE 4
Canister of Large Capacity (1000 cm³)

| | | | | Discharge | | |
|---|---|---|---|---|---|---|
| Sample | Water | | Gas | Time/s | Liquid | Average |
| No. | wt./g | Pressure/barg | wt./g | (approx) | Discharged/% | Flowrate/g s−¹ |
| 1 | 61.73 | 7 | 13.07 | 101 | 96.82 | 0.59 |
| 2 | 61.69 | 10 | 18.78 | 83 | 97.32 | 0.72 |
| 3 | 61.95 | 13 | 24.18 | 74 | 96.31 | 0.81 |

| | | | | |
|---|---|---|---|---|
| 4 | 61.56 | 10 | 18.57 | Employed for flowrate tests |

From the results, in order to achieve effective discharge (90 plus %) it appears essential to configure the container assembly to achieve an average flow rate of greater than 0.40 g/s for a liquid with a density of 1.

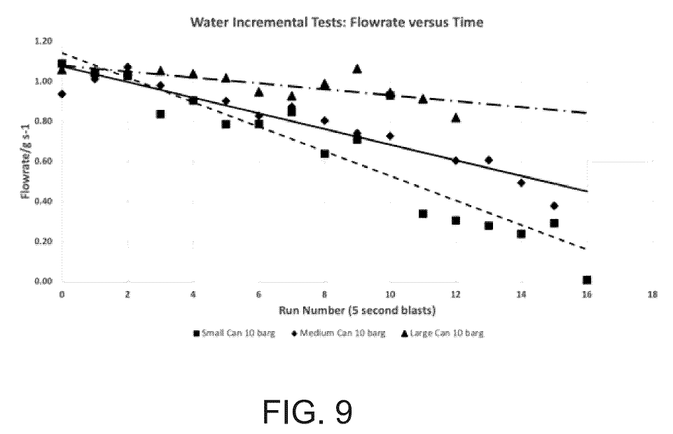

The benefit of a large canister is apparent from FIG. 9—see Example 4 below.

However, what is apparent from the results is that it is possible to achieve effective discharge by carefully controlling a number of inter-related variables, including:
a. Container volume;
b. Ingredient volume and density;
c. Dispensing gas pressure; and
d. By using a reducer selecting the diameters of the gas flow conduit orifice (340) and ingredient (liquid) conduit orifice (320) along which the dispensing gas and ingredient travel ahead of mixing in the actuator mixing chamber (280).

A skilled person will be able to determine appropriate values for c and d and from a and b by trial and error without undue burden.

Clearly, the use of pressures greater than 7 barg and more particularly 10 barg and higher, more preferably still greater than 11, 12, 13, to 13.5 or higher, if permitted, at 20° C. are most desired as this allows, in turn, the flow rate to be increased.

The desired flow rate is greater than 0.50 g/s more particularly still more than 0.55 through 0.60, 0.65, 0.70, 0.75 to as much as 0.80 g/s or more.

Such flow rates can be more easily achieved by increasing the volume of dispensing gas, or alternatively, the gas weight (above 6.5 g for CO₂).

CO₂ appears to be a particularly favourable gas as it dissolves well in water and some organic liquids.

Clearly it is much more soluble than the two primary aerial gases nitrogen and oxygen—See FIGS. 8A to 8C. This approximately ×100 factor difference in solubility is functionally highly significant because it facilitates aerosolization. The finer droplets formed as the CO₂ expands on leaving the liquid as it is dispersed provides a dryer spray which is highly desirable in many of the applications discussed.

### Example 4

The containers designated Sample 4 in the above Tables, for each can size, were used in subsequent flowrate tests. In these tests, each container was discharged in 5 s increments and the weights recorded after each discharge enabling the flowrate to be calculated. This flowrate was plotted against the run number (each run representing a 5 s interval) and is illustrated in FIG. 9. The temperature of the canister was restored to room temperature following each discharge by immersion into a thermostatic bath, controlled at 22° C. At the end of the discharge, on opening the canister, all the bags were found to contain minimal amounts of water residue, corresponding to a discharge of approximately >95%.

FIG. 9 shows that the large can, with the largest gas reservoir, gives a flatter line than the smaller canisters. This means that the flowrate is more consistent for the large can and that the flow drops more slowly with successive discharges. During these incrementally discharged runs, the average flowrate for the small canister is estimated to be 0.69±0.30 g s⁻¹. For the medium size canister, 0.81±0.17 g s⁻¹, and for the large size canister, 0.99±0.08 g s⁻¹. However, it may be considered excessive to use a canister of approximately 1 litre in size to dispense what is effectively 60 cm³ of active ingredient and the medium sized can appears to be a reasonable compromise.

Thus, compressed gas may be employed with the dual valve to provide acceptable atomization and aerosolization providing that the can size is selected to supply a sufficient gas reservoir. The pressure must also be chosen to enable sufficient discharge of the contents without exceeding the flowrate requirements. Finally, the valve restriction inserts must be chosen, in terms of the relative area ratios, to provide an optimal balance between the liquid and gas flows. The choice of whether to use a bag or a dip-leg attached to the valve depends upon the importance placed on the facility to invert, the need for the product and the propellant to be separated, and the need for the product to be confined.

Additionally, following its discharge, it is found that the bag can be re-filled and the canister re-gassed multiple times for continual re-use.

### Example 5

Using similar conditions to those outlined in Example 4, a bag was filled with 59.8 cm³ of pure propylene glycol and the can was filled with 10 barg pressure of carbon dioxide. After expelling through the actuator with a good initial plume, it was found that only 19.1% of the liquid had been discharged.

Highly viscous products undoubtedly provide a challenge to the employment of compressed gases in aerosol propellancy. Generally, the flowrate of a liquid through a valve is proportional to the radius of the valve orifice raised to the power 4 and inversely proportional to the viscosity. Hence, to facilitate the flow of a viscous liquid, the valve orifice (and actuator) carrying the liquid product may need to be increased.

1. A dispenser, comprising a dispenser container filled with a dispensing aerial carrier gas fitted with a valve assembly, the valve assembly including:
a mounting cup;
at least one gasket;
a valve seat;
a spring;
a housing; and
a dividing boss including a first fitment and a second fitment;
wherein the dispenser container is absent of an adsorbent and is at least one of:
partially filled with an ingredient for dispensing; and
the ingredient for dispensing is contained in an ingredient containing reservoir;
wherein the first fitment of the dividing boss, along which the ingredient is carried, is connected to at least one of:
a dip tube; and
a tube and ingredient containing reservoir;
wherein, on actuation, the ingredient travels out via the first fitment of the dividing boss and the dispensing aerial carrier gas travels out via the second fitment of the dividing boss via a reducer insert which manages respective flow rates of the dispensing aerial carrier gas and the ingredient allowing the ingredient and the dispensing aerial carrier gas to mix within a mixing chamber of an actuator assembly such that at least one of substantial atomization and substantial aerosolization of the ingredient occurs on discharge when exiting the dispenser container via an actuator spray nozzle to at least one of an environment and a subject at an average flow rate of at least 0.4 g/s;
wherein the dispensing aerial carrier gas is carbon dioxide having a pressure of at least 7 barg; and
wherein the ingredient is an aqueous system.

2. The dispenser as claimed in claim 1, wherein at least one of the second fitment and a tube is absent of at least one of a frit and a filter.

3. The dispenser as claimed in claim 1, wherein the flow rates are controlled by matching:
a container volume;
an ingredient volume;
a dispensing gas pressure; and
reducer conduit diameters such that a diameter of a reducer aerial carrier gas conduit is narrower than a diameter of a reducer ingredient conduit.

4. The dispenser as claimed in claim 3, wherein a ratio of a diameter of a reducer aerial carrier gas conduit orifice to a diameter of an ingredient conduit orifice is from 1:2 to 1:8.

5.-10. (canceled)

11. The dispenser as claimed in claim 1, wherein the ingredient is present as a dispersion.

12. The dispenser as claimed in claim 1, wherein the ingredient is contained in the dispenser container.

13. The dispenser as claimed in claim 1, wherein the ingredient is contained in the ingredient containing reservoir.

14. The dispenser as claimed in claim 13, wherein the ingredient containing reservoir is at least one of a bag and a pouch.

15. The dispenser as claimed in claim 13, further comprising at least three fitments and at least two ingredient containing reservoirs including different ingredients.

16. The dispenser as claimed in claim 1, further comprising a metering device.

17. The dispenser as claimed in claim 16, wherein the metering device includes a mechanism for adjusting a spray length to ensure dose to dose consistency.

18. The dispenser as claimed in claim 1, wherein the dispenser is absent of at least one of a liquified propellant, a hydrocarbon-based propellant, and a fluorocarbon-based propellant.

19. The dispenser as claimed in claim 1, wherein the ingredient is at least one of a deodorant, a fragrance, a flavour, a pheromone, a pesticide, a nutraceutical, a pharmaceutical, and a healthcare product.

20. A method of delivering an ingredient from a dispenser which is absent of an adsorbent and includes a dispensing aerial carrier gas, the method comprising:
releasing the ingredient from at least one of a dispenser container and an ingredient containing reservoir under pressure together with the dispensing aerial carrier gas which is also released on actuation of a valve assembly;
flowing the ingredient and the dispensing aerial carrier gas respectively along a first fitment and a second fitment to a reducer insert and along respectively a reducer aerial carrier gas conduit and a reducer ingredient conduit;
managing a respective flow rate of the dispensing aerial carrier gas and the ingredient via the reducer aerial carrier gas conduit and the reducer ingredient conduit; and
allowing the ingredient and the dispensing aerial carrier gas to mix within a mixing chamber of an actuator assembly such that at least one of a substantial atomization and a substantial aerosolization of the ingredient occurs on discharge when exiting the dispenser container via an actuator spray nozzle to at least one of an environment and a subject at an average flow rate of at least 0.4 g/s;
wherein the dispensing aerial carrier gas is carbon dioxide having a pressure of at least 7 barg; and
wherein the ingredient is an aqueous system.

21. (canceled)

22. The method as claimed in claim 20, wherein the dispensing aerial carrier gas passes along the reducer aerial carrier gas conduit which has a diameter that is narrower than a diameter of the reducer ingredient conduit.

23. The method as claimed in claim 20, wherein a ratio of a diameter of a reducer aerial carrier gas conduit orifice to a diameter of an ingredient conduit orifice is from 1:2 to 1:8.

24.-30. (canceled)

31. A dispenser, comprising a metering device and a dispenser container filled with a dispensing aerial carrier gas fitted with a valve assembly, the valve assembly including:
a mounting cup;
at least one gasket;
a valve seat;
a spring;
a housing; and
a dividing boss including a first fitment and a second fitment;
wherein the dispenser container is absent of an adsorbent and is at least one of:
partially filled with an ingredient for dispensing; and
the ingredient for dispensing is contained in an ingredient containing reservoir;
wherein the first fitment of the dividing boss, along which the ingredient is carried, is connected to at least one of:
a dip tube; and
a tube and ingredient containing reservoir;
wherein, on actuation, the ingredient travels out via the first fitment of the dividing boss and the dispensing aerial carrier gas travels out via the second fitment of the dividing boss via a reducer insert which manages respective flow rates of the dispensing aerial carrier gas and the ingredient allowing the ingredient and the dispensing aerial carrier gas to mix within a mixing chamber of an actuator assembly such that at least one of substantial atomization and substantial aerosolization of the ingredient occurs on discharge when exiting the dispenser container via an actuator spray nozzle to at least one of an environment and a subject at an average flow rate of at least 0.4 g/s;
wherein the dispensing aerial carrier gas is carbon dioxide having a pressure of at least 7 barg;
wherein the ingredient is an aqueous system; and
wherein the dispenser is absent of at least one of a liquified propellant, a hydrocarbon-based propellant, and a fluorocarbon-based propellant.

32. The dispenser as claimed in claim 31, wherein the second fitment is absent of at least one of a frit and a filter.

33. The dispenser as claimed in claim 31, wherein the flow rates are controlled by matching:
a container volume;
an ingredient volume;
a dispensing gas pressure;
a diameter of a reducer ingredient conduit of the reducer insert; and
a diameter of a reducer aerial carrier gas conduit of the reducer insert, which is narrower than the diameter of the reducer ingredient conduit.

34. The dispenser as claimed in claim 33, wherein a ratio of the diameter of the reducer aerial carrier gas conduit to the diameter of the ingredient conduit is from 1:2 to 1:8.
